(19) United States
(12) Patent Application Publication
(10) Pub. No.: US 2012/0286946 A1
(43) Pub. Date: Nov. 15, 2012

(54) FULLY SUPERVISED SELF TESTING ALARM NOTIFICATION APPARATUS

(76) Inventors: Thomas F. Karl, Lindenhurst, NY (US); Jorge D. Hevia, Lynbrook, NY (US)

(21) Appl. No.: 13/107,939

(22) Filed: May 15, 2011

(51) Int. Cl. G08B 29/16; H04R 29/00

(52) U.S. Cl. 340/516; 340/514; 381/58

(57) ABSTRACT

A method of testing audio emergency notification apparatuses which are provide to alert occupants of a building that an emergency condition which requires action is occurring, includes activating a control panel manually or automatically to test an audio apparatus, instructing the control panel to test the audio apparatuses either one by one, sequentially or simultaneously and generating a test signal for testing the apparatuses which is sent via closed circuit or radio frequency to each audio apparatus. The test signal causes each apparatus to generate an audio signal, the level or frequency of which from each apparatus is measured with a calibrated microphone and is sent to a selected destination.

### BACKGROUND OF THE INVENTION

1. Field of the Invention

This invention relates to emergency apparatus typically used by Fire Alarm Control Panels to indicate an emergency condition and providing a method for the self-testing and supervision of these devices. A fire alarm notification apparatus is an active fire protection apparatus, that, when activated, alerts occupants to the emergency condition to ensure proper evacuation of the premise. A notification apparatus may use audible and/or visible stimuli to alert the occupants of a fire or other emergency condition requiring action.

2. Background of the Invention

Due to the advent of the Americans with Disabilities Act (ADA) requirements, commercial Fire Alarm installations today may utilize more notification apparatus than initiating devices. This is intended to ensure that the hearing impaired who cannot hear a bell or horn indicate an emergency can observe the flashing of a strobe light. Conversely, it must be ensured that the sight impaired, who cannot see the flash of a strobe light must be able to hear a bell or horn. In many cases, this will require many more notification apparatus than required prior to the enforcement of the ADA act. A larger installation may have hundreds of apparatus, with a typical requirement of at least one device in every room or open area of the building.

It is extremely difficult to test all sounding apparatus in a facility. The current testing method requires that all notification apparatus be put into an alarm condition simultaneously in order for the technician to manually observe that all apparatus have actually activated. This requires that the devices sound in the alarm condition for the duration of the test, which may take a considerable length of time, depending on the number of apparatus. The technician must walk from room to room and manually record the audible and visual operation of each device.

Facilities such as public places, libraries and businesses will not allow testing (sounding of the apparatus) during their regular business hours. Facilities such as hospitals will NEVER allow the testing of all apparatus at any time. These issues raise severe liability concerns.

### SUMMARY OF THE INVENTION

In an exemplary embodiment of the present invention, there is disclosed a method of testing audio emergency notification apparatus which are provided to alert occupants of a building that an emergency condition which requires action is occurring, comprises:
activating a control panel manually or automatically to test an audio apparatus;
instructing the control panel to test audio apparatuses either one by one, sequentially or simultaneously;
generating a test signal for testing the apparatuses;
sending the test signal via closed circuit or radio frequency to each audio apparatus;
using the test signal to cause each apparatus to generate an audio signal;
measuring the level or frequency of sound from each apparatus with a calibrated microphone; and
sending the information which is measured to a selected destination.

This invention advantageously provides a method having the ability to test (supervise) its own circuitry to ensure that the apparatus is always ready to indicate an alarm condition, and operate within its specified parameters. The invention provides a method that is more reliable, due to the fact that it can be tested at much more frequent intervals than current methods which require manual testing. The invention also provides a method that offers much more economical operation over the life of the device, due to the fact that the alarm company will save the considerable labor presently required to manually test the apparatuses, as required by the present technology.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIGS. 1, 2, and 3 is a flow diagram of a method of manually or automatically testing the operation of one or a plurality of visual or audio emergency safety responder apparatuses such as smoke detectors, CO detectors, CO2 detectors, temperature detectors, etc., either one by one, separately, or sequentially and reporting the results of the test in accordance with the principles of the invention;

FIG. 4 is a flow diagram of a method for self testing of the alarm notification apparatus having intelligent communication with control panel; and

FIG. 5 is a flow diagram of a method for self testing alarm notification apparatus with generic NAC stand alone operation.

### DESCRIPTION OF THE PREFERRED EMBODIMENT

### Intelligent Self Testing Notification Apparatus

The notification apparatus described relates to a method of testing the status of the emergency apparatus devices and their notification circuits to ensure that they are capable of indicating an alarm condition should an emergency arise.

### Sounding Apparatus

In the instance where the alert portion of the apparatus includes an integral calibrated microphone and the apparatus generates an audio signal, the method disclosed determines if the apparatus is capable of sounding an alarm at the required dB level. During the test activation of the apparatus, the audio sounder such as a horn, high frequency noise generator, etc., will sound a brief burst that is just long enough to be measured by the integral calibrated microphone and its associated circuitry.

### Visual Apparatus

In the instance where the alert portion of the apparatus includes an integral optical sensor (photocell) and the apparatus generates an optical signal, the method disclosed determines if the apparatus is capable of generating an optical signal such as a burst of strobe light of the required level. Associated circuitry, or similar technology will test the light level of the strobe to make sure it is capable of indicating an alarm at the required level. The test activation of the lamp would initiate a brief flash of light which would be observed by the integral calibrated photo detection device and its associated circuitry.

### Notification Apparatus Circuit (NAC) Intelligent Communication

One embodiment of this invention provides an intelligent self-testing notification apparatus that is capable of bidirectional communication with the control panel. The panel Notification Apparatus Circuit (NAC), which drives the notification apparatus, uses firmware and hardware circuitry that allow it to communicate with all notification apparatus in the loop.

This allows the panel to:

Issue a “test” command that prompts the devices to briefly activate their notification devices and report the results back to the control panel. These results include the actual decibel level recorded by the testing circuitry of the sounding apparatus and the actual light level recorded by the testing circuitry of the visual notification apparatus. The panel may have the capability to log the results, by apparatus, for review by the technician or AHJ. This test may be a manually initiated or scheduled test.

Set the desired dB level of the sounding devices and the light level of the visual devices through the software program of the control panel, which would communicate these settings to the notification apparatus.

### Generic NAC “Stand-Alone” Operation

An embodiment of this invention provides a self-testing notification apparatus that may be connected to the NAC circuit (Notification Apparatus Circuit) of any control panel, and still offer the benefits of the self testing operation. In this “stand-alone” mode, the device would “self-test” on an internal schedule determined by the installer or AHJ. Upon failure of the “self-test” the device would provide local indication, such as the lighting of an LED or the sounding of a local trouble sounder or activation of a trouble relay or similar electronic output that may be connected to a zone on the control panel.

The method disclosed eliminates the liability concerns resulting from prior art notification apparatus testing procedures. One embodiment of this invention provides an intelligent self-testing notification apparatus testing policy, making full fire alarm inspections and system testing non-intrusive and possible in all installations. It greatly streamlines the maintenance and testing of the system, making the inspection division of the alarm company much more efficient and profitable.

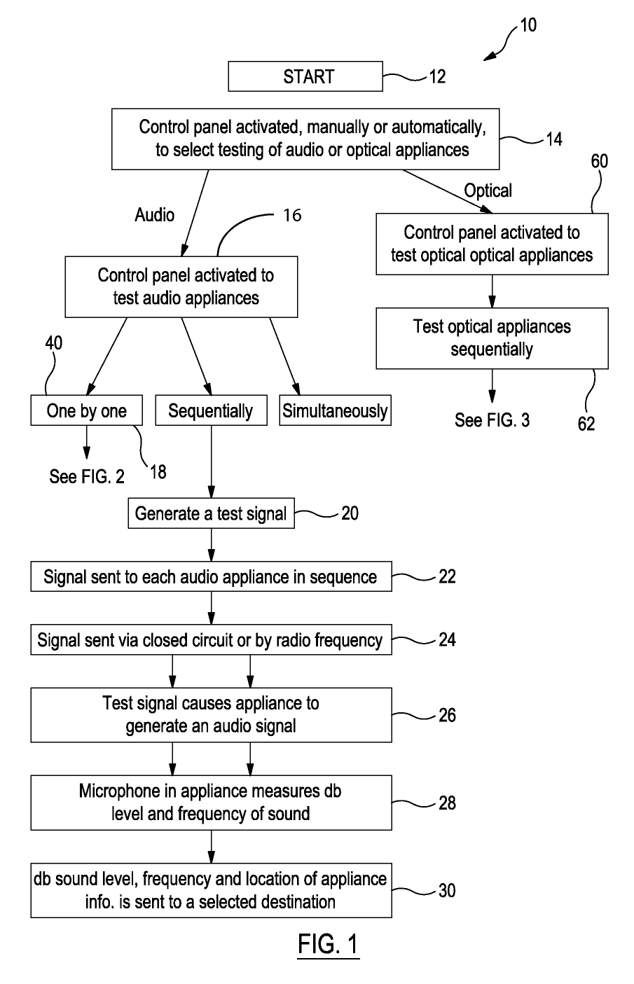

Referring to FIG. 1, there is disclosed a flow diagram 10 of a method of manually or automatically testing the operation of one or a plurality of visual and audio emergency safety apparatus such as smoke detectors, CO detectors, CO2 detectors, temperature detectors, etc., either separately, sequentially or simultaneously while in operational service and recording and/or reporting the results of the test in accordance with the principles of the invention.

At the start, block 12, the control panel is activated to test either optical or audio apparatus, block 14. Audio devices are selected and the control panel is instructed to test the various apparatuses either one by one, sequentially or simultaneously, block 16. The control panel is instructed to test the apparatuses sequentially, block 18. The control panel generates a test signal, block 20, which has a specific duration and which is sent in sequence to each audio apparatus, block 22. The test signal can be sent to each apparatus either through a closed circuit or via a predetermined radio frequency, block 24. Upon receipt of test signal, apparatus generates a brief audio signal, block 26. A microphone which is located in the apparatus measures the db level and the frequency of the sound, block 28. The db level, frequency and location of apparatus is sent to a destination, block 30, which may be the control panel or a central location of the testing service. The information may be in the form of raw data or a report. The control panel may be capable of generating a report, listing the test results and current status of each apparatus in the system. The apparatus may be responsive to accept commands which set the parameters of the audio apparatus which may include resetting the volume and frequency of the apparatus.

The apparatus may be connected to a generic NAC circuit of a control panel to operate in a stand alone mode where it would self test on an internal schedule determined by the installer or AHJ. Upon failure of the self test the apparatus would provide local indication, such as the lighting of an LED or the sounding of a local trouble sounder. Failure would also be indicated by means of an electronic relay output or other electronic trouble output, such as an open collector output that may be connected to the control panel, which would allow it to locally indicate the trouble and/or report it to a central monitoring station.

The apparatus may be connected to a generic NAC circuit of a control panel to operate in a stand alone mode where the apparatus is capable of storing the results of its self test in an internal memory buffer. Local means can be provided for the technician or the AHJ to read out the value when required.

The apparatus may be connected to a module by electronic circuitry and communication protocol that allows it to return the results of the apparatus test to the remote NAC module, which in turn may be capable of generating a report for the AHJ, listing the test results and current status of each notification apparatus in the system.

The apparatus may be connected to a remote NAC module by electronic circuitry and communication protocol that allows it to accept commands to set the parameters of the audio apparatus which may include volume, frequency, etc.

The apparatus may be adapted to function with technology other than a microphone which is capable of measuring acoustic sound pressure which is used to monitor the performance of the sounding device to make sure it is operating within its specified audible range.

In the event that the apparatus is not operating at its designed specifications, the control panel may send a signal to the apparatus which will recalibrate the apparatus or identify the apparatus by activating a bright LED to indicate to a service person that the apparatus must be replaced.

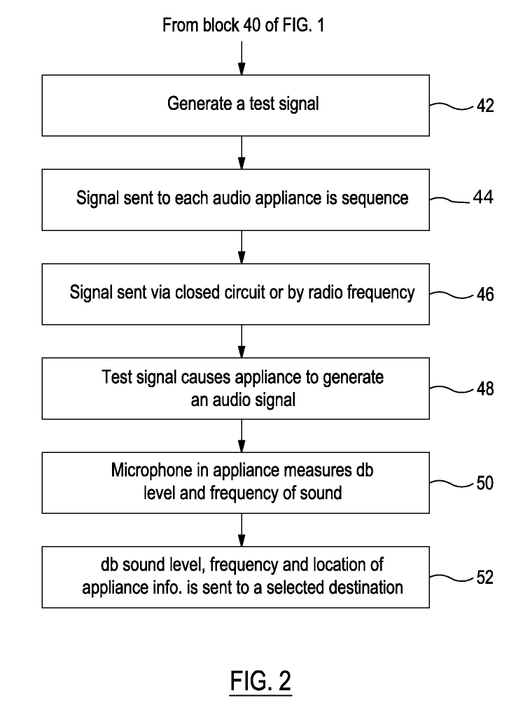

Returning to block 16, the control panel is instructed to test the apparatuses one by one, block 18. Looking at FIG. 2, the control panel generates a test signal, block 42, which has a specific duration and which is sent in sequence to each audio apparatus, block 44. The test signal can be sent to each apparatus either through a closed circuit or via a predetermined radio frequency, block 46. Upon receipt of test signal, the apparatus generates a brief audio signal, block 48. A microphone which is located in the apparatus measures the db level and the frequency of the sound, block 50. The db level, frequency and location of apparatus is sent to a destination, block 52, which may be the control panel or a central location of the testing service. The information may be in the form of raw data or a report. The control panel may be capable of generating a report, listing the test results and current status of each apparatus in the system. The apparatus may be responsive to accept commands which set the parameters of the audio apparatus which may include resetting the volume and frequency of the apparatus.

The apparatus may be connected to a generic NAC circuit of a control panel to operate in a stand alone mode where it would self test on an internal schedule determined by the installer or AHJ. Upon failure of the self test the apparatus would provide local indication, such as the lighting of an LED or the sounding of a local trouble sounder. Failure may also be indicated by means of an electronic relay output or other electronic trouble output, such as an open collector output that may be connected to the control panel, which would allow it to locally indicate the trouble and/or report it to a central monitoring station.

The apparatus may be connected to a generic NAC circuit of a control panel to operate in a stand alone mode where the apparatus is capable of storing the results of its self test in an internal memory buffer. Local means can be provided for the technician or the AHJ to read out the value when required.

The apparatus may be connected to a module by electronic circuitry and communication protocol that allows it to return the results of the apparatus test to the remote NAC module, which in turn may be capable of generating a report for the AHJ, listing the test results and current status of each notification apparatus in the system.

The apparatus may be connected to a remote NAC module by electronic circuitry and communication protocol that allows it to accept commands to set the parameters of the audio apparatus which may include volume, frequency, etc.

The apparatus may be adapted to function with technology other than a microphone which is capable of measuring acoustic sound pressure which is used to monitor the performance of the sounding device to make sure it is operating within its specified audible range.

In the event that the apparatus is not operating at its designed specifications, the control panel may send a signal to the apparatus which will recalibrate the apparatus or identify the apparatus by activating a bright LED to indicate to a service person that the apparatus must be replaced.

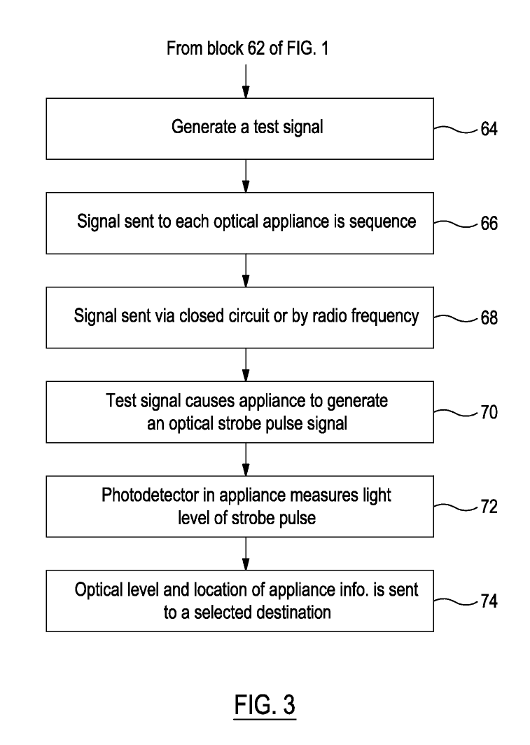

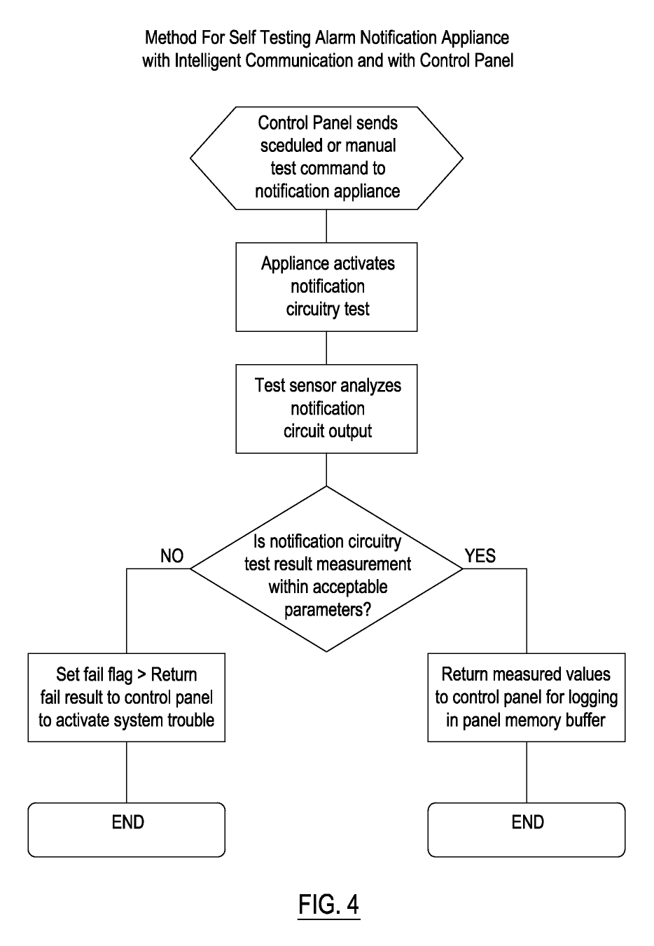

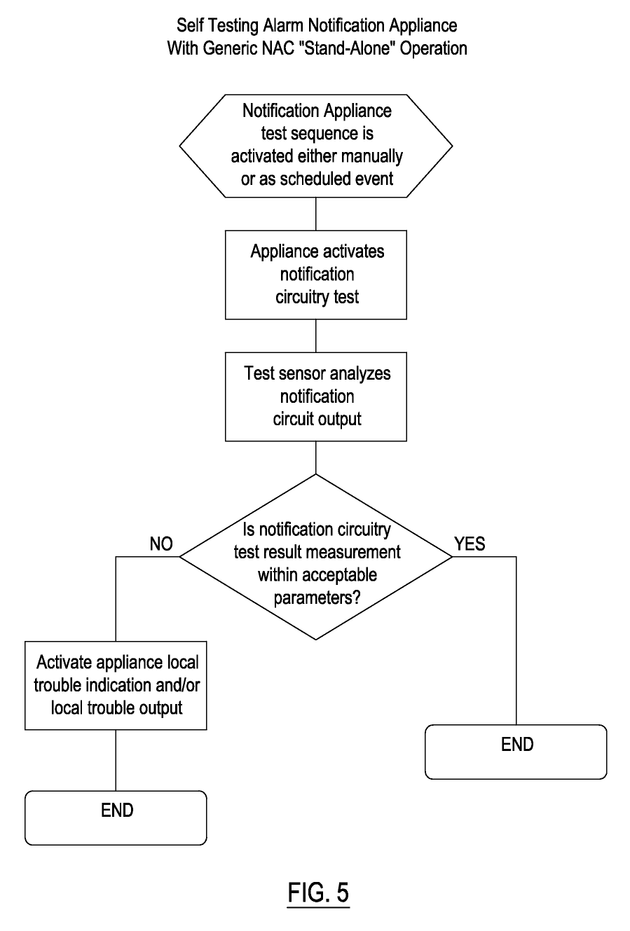

Returning to block 14, the control panel is instructed to test optical apparatuses block 60, and the control panel is activated to test optical apparatuses in a building in sequence, block 62. Looking at FIG. 3, the control panel generates a test signal, block 64, which has a specific duration and which is sent in sequence to each optical apparatus, block 66. The test signal can be sent to each apparatus either through a closed circuit or via a predetermined radio frequency, block 68. Upon receipt of test signal, the apparatus generates a brief optical signal such as one or two flashes of a strobe lamp, block 70. An optical sensor such as a photo detector which is located in the apparatus measures the intensity of the strobe light, block 72. The intensity such as the lumen output of the light pulse and location of the apparatus is sent to a destination, block 74, which may be the control panel or a central location of the testing service. The information may be in the form of raw data or a report. The control panel may be capable of generating a report, listing the test results and current status of each apparatus in the system. The apparatus may be responsive to accept commands which set the parameters of the optical apparatus which may include resetting the light output and time between pulses of the apparatus.

The apparatus may be connected to a generic NAC circuit of a control panel to operate in a stand alone mode where it would self test on an internal schedule determined by the installer or AHJ. Upon failure of the self test the apparatus would provide local indication, such as the lighting of an LED or the sounding of a local trouble sounder. Failure may also be indicated by means of an electronic relay output or other electronic trouble output, such as an open collector output that may be connected to the control panel, which would allow it to locally indicate the trouble and/or report it to a central monitoring station.

The apparatus may be connected to a generic NAC circuit of a control panel to operate in a stand alone mode where the apparatus is capable of storing the results of its self test in an internal memory buffer. Local means can be provided for the technician or the AHJ to read out the value when required.

The apparatus may be connected to a module by electronic circuitry and communication protocol that allows it to return the results of the apparatus test to the remote NAC module, which in turn may be capable of generating a report for the AHJ, listing the test results and current status of each notification apparatus in the system.

The apparatus may be connected to a remote NAC module by electronic circuitry and communication protocol that allows it to accept commands to set the parameters of the optical apparatus which may include the intensity of the light pulse, time between pulses, etc.

The apparatus may be adapted to function with technology other than a photo detector which is capable of measuring the intensity or brightness of the light generated which is used to monitor the performance of the optical device to make sure it is operating at its designed specification levels.

In the event that the apparatus is not operating at its designed specifications, the control panel may send a signal to the apparatus which will recalibrate the apparatus or identify the apparatus by activating a bright LED to indicate to a service person that the apparatus must be replaced.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of testing audio emergency notification apparatuses which are provided to alert occupants of a building that an emergency condition which requires action is occurring, comprises:
activating a control panel manually or automatically to test an audio apparatus;
instructing the control panel to test audio apparatuses either one by one, sequentially or simultaneously;
generating a test signal for testing the apparatuses;
sending the test signal via closed circuit or radio frequency to each audio apparatus;
using the test signal to cause each apparatus to generate an audio signal;
measuring the level or frequency of sound from each apparatus with a calibrated microphone; and
sending the information which is measured to a selected destination.

2. The method of claim 1 wherein the control panel is connected by electronic circuitry and communication protocol that allows it to transmit the status of the audio apparatus.

3. The method of claim 1 wherein the control panel is connected by electronic circuitry and communication protocol that allows it to respond to test commands from the control panel, allowing the apparatus to be tested either on demand or on a schedule set in the control panel program.

4. The method of claim 1 wherein electronic circuitry and communication protocol allows the calibrated microphone to return the results of the test to the control panel, which in turn is capable of generating a report for an AHJ listing the test results and current status of each tested apparatus.

5. The method of claim 1 wherein the audio apparatus is connected to the control panel by electronic circuitry and communication protocol that allows it to accept commands to set the parameters of the audio apparatus which include volume or frequency.

6. The method of claim 1 wherein the audio apparatus is connected to a generic Notification Apparatus Circuit of the control panel which “self-tests” on an internal schedule determined by an installer or an AHJ and upon failure of the “self-test” the apparatus provides local indication by the lighting of an LED or the sounding of a local trouble sounder or wherein failure is indicated by an electronic relay output or other electronic trouble output connected to the control panel, which allows it to locally indicate the trouble or report it to a central monitoring station.

7. The method of claim 1 wherein the audio apparatus is connected to a generic Notification Apparatus Circuit of the control panel that operates on a stand alone mode stores the results of its self test in an internal memory buffer; wherein the results of the self test are provided for readout by a technician or an AHJ.

8. The method of claim 1 wherein the audio apparatus is connected to a Notification Apparatus Circuitry module of the control panel by electronic circuitry and communication protocol which allows it to return the results of the audio apparatus test to a remote NAC module which in turn is capable of generating a report for an AHJ which lists the results and current status of each tested audio apparatus.

9. The method of claim 1 wherein the audio apparatus is connected to the Notification Appliance Circuit of the control panel by electronic circuitry and communication protocol allows it to accept commands to set the parameters of the audio apparatus which include volume or frequency.

10. The device of claim 1 wherein an audio apparatus other than a microphone capable of measuring acoustic sound pressure is used to monitor the performance of the audio apparatus to determine if the audio apparatus is operating within its specified audible range.

11. A method of testing optical emergency notification apparatus provide to alert occupants of a building that an emergency condition which requires action is occurring, comprises:
activating a control panel manually or automatically to test an optical apparatus;
instructing the control panel to test optical apparatuses either one by one, sequentially or simultaneously;
generating a test signal for testing the apparatuses sequentially;
sending the test signal via closed circuit or radio frequency to each optical apparatus;
using the test signal to cause each apparatus to generate an optical signal;
measuring the level or frequency of light from each apparatus with a calibrated photo detector; and
sending the information which is measured to a selected destination.

12. The method of claim 11 wherein the control panel is connected by electronic circuitry and communication protocol that allows it to transmit the status of the optical apparatus device.

13. The method of claim 11 wherein the control panel is connected by electronic circuitry and communication protocol that allows it to respond to test commands from the control panel, allowing the optical apparatus to be tested either on demand or on a schedule set in the control panel program.

14. The method of claim 11 wherein electronic circuitry and communication protocol allows the photo detector to return the results of the test to the control panel, which in turn is capable of generating a report for an AHJ listing the test results and current status of each tested apparatus in the system.

15. The method of claim 11 wherein the optical apparatus is connected to the control panel by electronic circuitry and communication protocol that allows it to accept commands to set the parameters of the optical apparatus which includes volume or frequency.

16. The method of claim 11 wherein the optical apparatus is connected to a generic Notification Appliance Circuit of the control panel that “self-tests” on an internal schedule determined by an installer or an AHJ and upon failure of the “self-test” the optical apparatus provides local indication by the lighting of an LED or the sounding of a local trouble sounder or wherein failure is indicated by an electronic relay output or other electronic trouble output connected to the control panel, which allows it to locally indicate the trouble or report it to a central monitoring station.

17. The method of claim 11 wherein the optical apparatus is connected to a generic Notification Appliance Circuit of the control panel that operates on a stand alone mode which stores the results of its self test in an internal memory buffer; wherein the results of the self test are provided for readout by a technician or an AHJ.

18. The method of claim 11 wherein the optical apparatus is connected to a Notification Appliance Circuit of the control panel by electronic circuitry and communication protocol which allows it to return the results of the optical apparatus test to a remote NAC module which is capable of generating a report for an AHJ which lists the results and current status of each tested optical apparatus.

19. The method of claim 11 wherein the optical apparatus is connected to a Notification Appliance Circuit of the control panel by electronic circuitry and communication protocol which allows it to accept commands to set the parameters of the optical apparatus which includes volume or frequency.

20. The device of claim 11 wherein an optical detection apparatus other than a calibrated photo detector capable of measuring light is used to monitor the performance of the optical apparatus to determine if the optical apparatus is operating within its specified optical range.
